(19) United States
(12) Patent Application Publication
(10) Pub. No.: US 2016/0277324 A1
(43) Pub. Date: Sep. 22, 2016

(54) INFORMATION PROCESSING APPARATUS,INFORMATION PROCESSING METHOD, AND NON-TRANSITORY COMPUTER READABLE MEDIUM

(71) Applicant: FUJI XEROX CO., LTD., Tokyo (JP)

(72) Inventors: Hisaji HIRAMATSU, Kanagawa (JP); Yuichi KAWATA, Kanagawa (JP); Takanori FUKUOKA, Kanagawa (JP); Kei HATANO, Kanagawa (JP); Tadamasa SAKAMAKI, Kanagawa (JP)

(73) Assignee: FUJI XEROX CO., LTD., Tokyo (JP)

(21) Appl. No.: 14/814,614

(22) Filed: Jul. 31, 2015

(30) Foreign Application Priority Data
Mar. 20, 2015 (JP) 2015-058635

(51) Int. Cl. H04L 12/931

(52) U.S. Cl. CPC H04L 49/65; H04L 49/20

(57) ABSTRACT

An information processing apparatus includes a network interface, a main arithmetic unit, a sub arithmetic unit, and a data switch. The main arithmetic unit is activated in response to power being supplied thereto, and performs arithmetic operation on the basis of a preset first program. The sub arithmetic unit performs arithmetic operation on the basis of a second program written by the main arithmetic unit. The data switch switches, under control of the sub arithmetic unit, a path of data communicated between the network interface and the main arithmetic unit or the sub arithmetic unit. The data switch is configured to communicate, in an initial state, the data between the network interface and the main arithmetic unit.

### CROSS-REFERENCE TO RELATED APPLICATIONS

This application is based on and claims priority under 35 USC 119 from Japanese Patent Application No. 2015-058635 filed Mar. 20, 2015.

### BACKGROUND

(i) Technical Field

The present invention relates to an information processing apparatus, an information processing method, and a non-transitory computer readable medium.

(ii) Related Art

In recent years, an apparatus that reduces power consumption by having a central processing unit (CPU) and a sub CPU that consumes less power than the CPU has been proposed.

In an apparatus that has a CPU and a sub CPU, the sub CPU performs setting of a network link speed and the like of an interface of a physical layer (PHY) device. To do the setting, a program necessary for causing the sub CPU to operate needs to be written in a memory. Therefore, it is necessary to write a program for causing the sub CPU to operate in a memory, and an activation time is thus delayed by a time involved in writing the program.

### SUMMARY

According to an aspect of the invention, there is provided an information processing apparatus including a network interface, a main arithmetic unit, a sub arithmetic unit, and a data switch. The main arithmetic unit is activated in response to power being supplied thereto, and performs arithmetic operation on the basis of a preset first program. The sub arithmetic unit performs arithmetic operation on the basis of a second program written by the main arithmetic unit. The data switch switches, under control of the sub arithmetic unit, a path of data communicated between the network interface and the main arithmetic unit or the sub arithmetic unit. The data switch is configured to communicate, in an initial state, the data between the network interface and the main arithmetic unit.

### BRIEF DESCRIPTION OF THE DRAWINGS

An exemplary embodiment of the present invention will be described in detail based on the following figures, wherein:

FIG. 1 is a diagram for describing an environment where an information processing apparatus is used;

FIG. 2 is a diagram for describing the configuration of the information processing apparatus;

FIG. 3 is a diagram for describing the functional configuration of an energy-saving controller;

FIG. 4 is a flowchart of an exemplary flow of a process performed at activation of the information processing apparatus;

FIG. 5 is a flowchart of an exemplary flow of a process performed when the information processing apparatus enters a power saving state; and

FIG. 6 is a flowchart of an exemplary flow of a process performed when the information processing apparatus enters a normal state.

### DETAILED DESCRIPTION

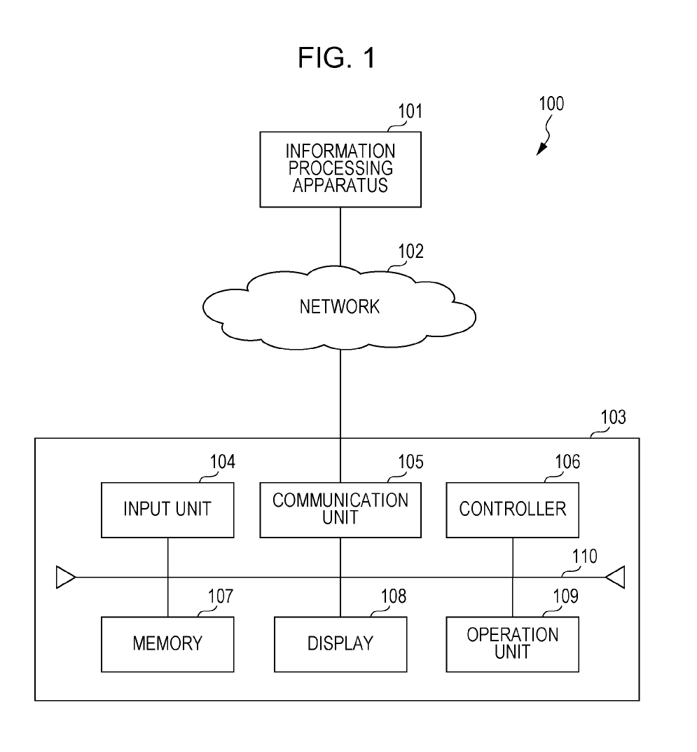

An exemplary embodiment for implementing the present invention will be described below in accordance with the drawings. In the drawings, the same or equivalent elements are labeled with the same reference numerals, and overlapping descriptions are omitted. FIG. 1 is a diagram for describing an environment where an information processing apparatus 101 according to the exemplary embodiment is used. As illustrated in FIG. 1, an information processing system 100 includes the information processing apparatus 101, a network 102, and an information terminal 103. The information processing apparatus 101 and the information terminal 103 communicate with each other via the network 102.

The information processing apparatus 101 includes, for example, a CPU and a memory. The information processing apparatus 101 is an apparatus that performs printing and scanning, and is connected to the information terminal 103 via the network 102. The configuration of the information processing apparatus 101 will be described in detail later.

The network 102 is, for example, a wide-area communication line that connects local area network (LAN) lines with one another. For example, as illustrated in FIG. 1, the network 102 connects the information processing apparatus 101 and the information terminal 103 through a LAN line. Here, a LAN line may be an internal network located between devices in a certain limited area, or may be the Internet.

The information terminal 103 is, for example, a personal computer (PC) or a smart phone including a CPU and a memory. The information terminal 103 includes an input unit 104, a communication unit 105, a controller 106, a memory 107, a display 108, an operation unit 109, and an internal bus 110. The input unit 104 is, for example, a Universal Serial Bus (USB) port or an optical drive, and receives data that is input from the outside. The communication unit 105 connects the information processing apparatus 101 and the information terminal 103 via the network 102.

The controller 106 is, for example, a CPU or a micro-processing unit (MPU). The controller 106 operates in accordance with a program stored in the memory 107. The memory 107 includes, for example, an information recording medium such as a read-only memory (ROM), a random-access memory (RAM), or a hard disk. The memory 107 is an information recording medium that holds a program executed by the controller 106. The memory 107 also operates as, for example, a work memory for the controller 106.

The display 108 is, for example, a liquid crystal display or an organic electroluminescence (EL) display. The display 108 displays information in accordance with an instruction from the controller 106. The operation unit 109 includes, for example, multiple buttons and a touch panel. In response to an instruction operation performed by the user, the controller 106 outputs the details of the instruction operation to the controller 106. The internal bus 110 interconnects the input unit 104, the communication unit 105, the controller 106, the memory 107, the display 108, and the operation unit 109. The configuration of the communication system described above is only one example, and is not limited to this example. For example, although one information terminal 103 is illustrated in FIG. 1, there may be multiple information terminals 103.

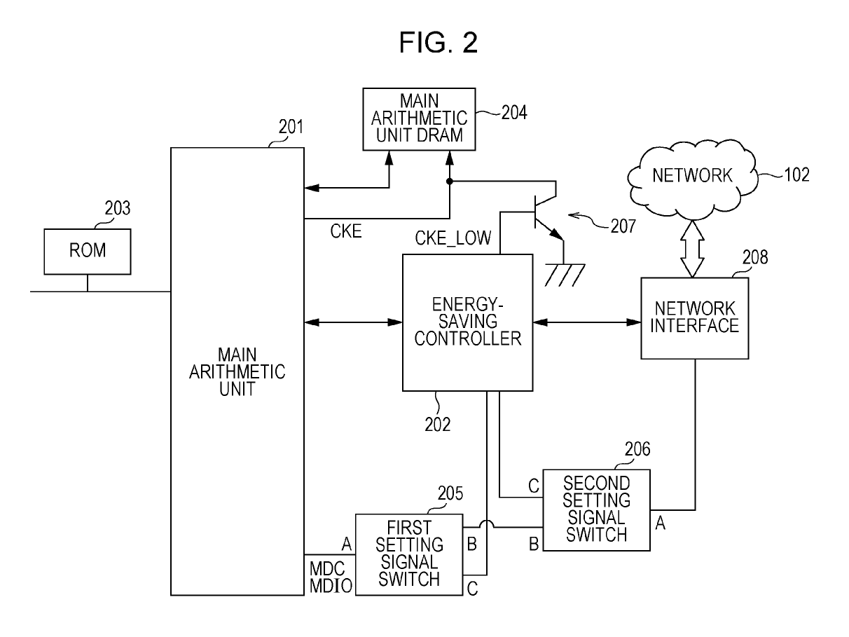

FIG. 2 is a diagram for describing the configuration of the information processing apparatus 101 according to the exemplary embodiment. As illustrated in FIG. 2, the information processing apparatus 101 includes a main arithmetic unit 201, an energy-saving controller 202, a ROM 203, a main arithmetic unit dynamic RAM (DRAM) 204, a first setting signal switch 205, a second setting signal switch 206, a transistor 207, and a network interface 208.

The main arithmetic unit 201 is activated in response to power being supplied thereto, and performs arithmetic operation on the basis of a main arithmetic unit program set in advance. Specifically, for example, in response to application of power to the information processing apparatus 101, power is supplied to the main arithmetic unit 201, thereby activating the main arithmetic unit 201. The main arithmetic unit 201 reads a main arithmetic unit program stored in advance in the ROM 203, and writes the program in the main arithmetic unit DRAM 204. In an activated state, the main arithmetic unit 201 performs arithmetic operation on the basis of the main arithmetic unit program, thereby communicating a setting signal or data to the main arithmetic unit DRAM 204, the energy-saving controller 202, the first setting signal switch 205, the second setting signal switch 206, and the network interface 208.

Specifically, for example, the main arithmetic unit 201 communicates a setting signal by using the main arithmetic unit DRAM 204 and an inter-integrated circuit (IIC). In addition, for example, the main arithmetic unit 201 controls the first setting signal switch 205 and the second setting signal switch 206. Furthermore, the main arithmetic unit 201 communicates a setting signal to the energy-saving controller 202 and the network interface 208 by using Serial Management Interface (SMI), and communicates data by using Reduced Gigabit Media Independent Interface (RGMII).

The main arithmetic unit 201 also determines whether the main arithmetic unit program has already been written in the main arithmetic unit DRAM 204, and, in the case where the main arithmetic unit 201 determines that the main arithmetic unit program has not been written at the time the main arithmetic unit 201 enters a power saving state, writes the main arithmetic unit program. Specifically, for example, since no program is written in the main arithmetic unit DRAM 204 immediately after the application of power to the information processing apparatus 101, the main arithmetic unit 201 writes the main arithmetic unit program, read from the ROM 203, into the main arithmetic unit DRAM 204. In this case, the main arithmetic unit 201 performs the above determination by using a program load bit representing whether the main arithmetic unit program has been loaded from the ROM 203, and an off flag register bit representing whether the information processing apparatus 101 is in a state that is immediately after the application of power to the information processing apparatus 101 or whether the information processing apparatus 101 is restored from a power saving state.

Furthermore, the main arithmetic unit 201 writes a sub arithmetic unit program in a sub arithmetic unit RAM 302 included in the energy-saving controller 202. Specifically, for example, before the main arithmetic unit 201 enters a power saving state, the main arithmetic unit 201 writes the sub arithmetic unit program in the sub arithmetic unit RAM 302 via the first setting signal switch 205. Note that the sub arithmetic unit RAM 302 will be described in detail later.

Although the main arithmetic unit 201 controls the entire information processing apparatus 101, in order to control the entire information processing apparatus 101, it is necessary to perform various processes at a high speed. Therefore, it is desirable to use a highly-functional and high-speed CPU. That is, the main arithmetic unit 201 has higher functionality and higher speed and consumes more power than those of a later-described sub arithmetic unit 301.

The energy-saving controller 202 communicates a setting signal or data to the network interface 208 in the case where the main arithmetic unit 201 is in a power saving state. Specifically, for example, in the case where the main arithmetic unit 201 is in a normal state, the energy-saving controller 202 passes through data communicated between the main arithmetic unit 201 and the network interface 208. The energy-saving controller 202 communicates a setting signal or data to the network interface 208 in place of the main arithmetic unit 201 in the case where the main arithmetic unit 201 is in a power saving state. Furthermore, the energy-saving controller 202 performs control to validate or invalidate a self-refresh function of the main arithmetic unit DRAM 204. The energy-saving controller 202 will be described in detail later.

The ROM 203 is a memory that stores the main arithmetic unit program. Specifically, for example, the ROM 203 is a non-volatile memory such as an electrically erasable programmable ROM (EEPROM), and stores a program for activating the main arithmetic unit 201, and a program for the main arithmetic unit 201 to communicate a setting signal or data to the energy-saving controller 202, the first setting signal switch 205, and the second setting signal switch 206.

The main arithmetic unit DRAM 204 is a main work RAM connected to the main arithmetic unit 201. Specifically, for example, the main arithmetic unit DRAM 204 is used as a buffer when the main arithmetic unit 201 performs arithmetic operation, or for temporal storage of data obtained from the network interface 208. It is preferable that the main arithmetic unit DRAM 204 include a circuit for performing refresh and have the function of automatically performing refresh in response to a certain command and application of power (hereinafter referred to as a self-refresh function). For example, it is preferable that the main arithmetic unit DRAM 204 have the function of invalidating the self-refresh function in the case where a CKE signal output from the main arithmetic unit 201 is high and to validate the self-refresh function in the case where a CKE signal output from the main arithmetic unit 201 is low.

Under control of the main arithmetic unit 201, the first setting signal switch 205 and the second setting signal switch 206 switch the path of a setting signal for the network interface 208, which is communicated between the network interface 208 and the main arithmetic unit 201 or the sub arithmetic unit 301. Specifically, the first setting signal switch 205 and the second setting signal switch 206 are each implemented by a 2-to-1 multiplexer, and perform switching control using a switching signal from the main arithmetic unit 201. For example, under control of the main arithmetic unit 201, the first setting signal switch 205 changes a connection destination of an input/output terminal of a setting signal from the main arithmetic unit 201 to the network interface 208 to the second setting signal switch 206 or the energy-saving controller 202. Also, under control of the main arithmetic unit 201, the second setting signal switch 206 changes a connection destination of an input/output terminal of a setting signal for the network interface 208 to the first setting signal switch 205 or the energy-saving controller 202.

The setting signal switches 205 and 206 are set to communicate a setting signal between the network interface 208 and the main arithmetic unit 201 immediately after application of power to the information processing apparatus 101. In transition of the main arithmetic unit 201 to a power saving state, the setting signal switches 205 and 206 are set to communicate a setting signal between the main arithmetic unit 201 and the energy-saving controller 202 and between the energy-saving controller 202 and the network interface 208, respectively, and to maintain their communication paths after the main arithmetic unit 201 is restored from a power saving state to a normal state. As described above, the setting signal communication paths are changed in accordance with the state of the main arithmetic unit 201.

For the following description, as illustrated in FIG. 2, a terminal of the first setting signal switch 205 that connects to the main arithmetic unit 201 is referred to as an A terminal; a terminal of the first setting signal switch 205 that connects to the second setting signal switch 206 is referred to as a B terminal; and a terminal of the first setting signal switch 205 that connects to the energy-saving controller 202 is referred to as a C terminal. Similarly, a terminal of the second setting signal switch 206 that connects to the network interface 208 is referred to as an A terminal; a terminal of the second setting signal switch 206 that connects to the first setting signal switch 205 is referred to as a B terminal; and a terminal of the second setting signal switch 206 that connects to the energy-saving controller 202 is referred to as a C terminal.

The transistor 207 performs control to validate or invalidate the self-refresh function of the main arithmetic unit DRAM 204 on the basis of an instruction from the energy-saving controller 202. Specifically, for example, in the case where a CKE_LOW signal from the energy-saving controller 202 is high, the transistor 207 forces the CKE signal to be low, thereby validating the self-refresh function of the main arithmetic unit DRAM 204. That is, in the case where the main arithmetic unit 201 is in a power saving state, a CKE signal output from the main arithmetic unit 201 becomes indefinite. Even in such a case, the transistor 207 forces the CKE signal to be low, thereby validating the self-refresh function of the main arithmetic unit DRAM 204. Although the case in which self-refresh mode control is performed using the transistor 207 has been described with FIG. 2, if the main arithmetic unit 201 is configured to have the function of validating the self-refresh function of the main arithmetic unit DRAM 204 in response to an instruction from the energy-saving controller 202 even in the case where the main arithmetic unit 201 is in a power saving state, the configuration may not include the transistor 207.

The network interface 208 is an interface that performs wired data communication with the information terminal 103 connected to the information processing apparatus 101. Specifically, for example, the network interface 208 includes a physical layer device (PHY).

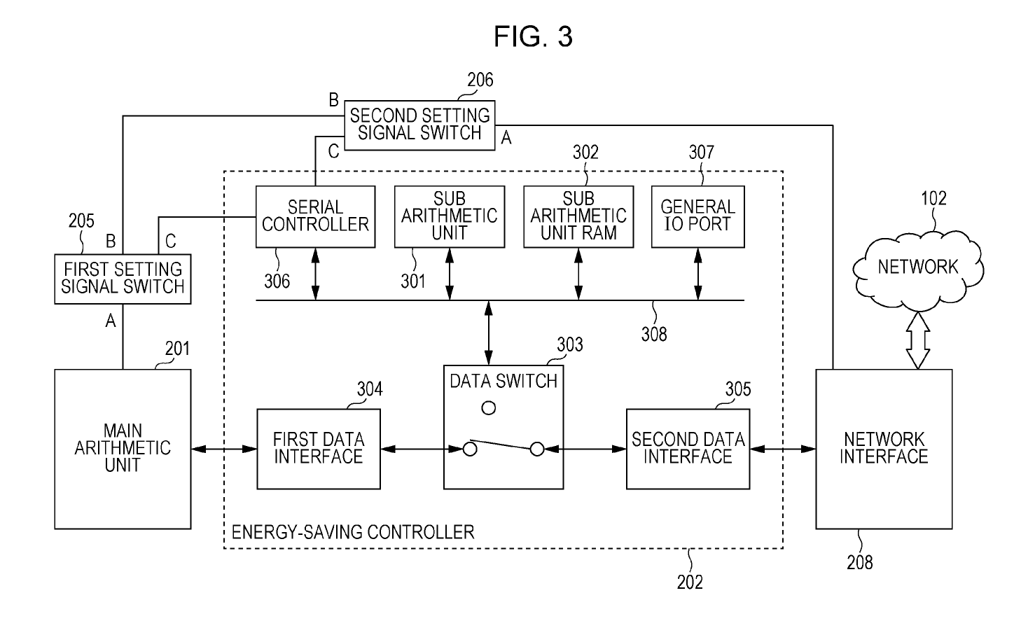

Next, the energy-saving controller 202 will be described in detail. FIG. 3 is a diagram for describing the configuration of the energy-saving controller 202 according to the exemplary embodiment. As illustrated in FIG. 3, the energy-saving controller 202 includes the sub arithmetic unit 301, the sub arithmetic unit RAM 302, a data switch 303, a first data interface 304, a second data interface 305, a serial controller 306, a general IO port 307, and a controller internal bus 308.

The sub arithmetic unit 301 performs arithmetic operation on the basis of the sub arithmetic unit program written by the main arithmetic unit 201. Specifically, for example, first, the sub arithmetic unit 301 is activated in response to obtaining of a reset cancellation signal transmitted by the main arithmetic unit 201. By performing arithmetic operation on the basis of the sub arithmetic unit program written by the main arithmetic unit 201 in the sub arithmetic unit RAM 302, the sub arithmetic unit 301 communicates a setting signal or data to the sub arithmetic unit RAM 302, the data switch 303, the serial controller 306, the general IO port 307, and the network interface 208. Since the sub arithmetic unit 301 need not perform high-speed operation for communicating with the information terminal 103, a CPU that consumes less power than the main arithmetic unit 201 is used as the sub arithmetic unit 301.

The sub arithmetic unit RAM 302 is a main work RAM connected to the sub arithmetic unit 301. Specifically, for example, the sub arithmetic unit RAM 302 is used as a buffer when the sub arithmetic unit 301 performs arithmetic operation, or for temporal storage of data obtained from the network interface 208.

Under control of the sub arithmetic unit 301, the data switch 303 switches the path of data communicated between the network interface 208 and the main arithmetic unit 201 or the sub arithmetic unit 301. Specifically, for example, the data switch 303 is set to communicate data between the network interface 208 and the sub arithmetic unit 301 in transition of the main arithmetic unit 201 to a power saving state. The data switch 303 is set to transfer data temporally stored by the sub arithmetic unit 301 in the sub arithmetic unit RAM 302 to the main arithmetic unit 201 when the main arithmetic unit 201 is restored from a power saving state to a normal state, and thereafter is set to communicate data between the network interface 208 and the main arithmetic unit 201. In an initial state, the data switch 303 is configured to communicate data between the network interface 208 and the main arithmetic unit 201. Here, it is preferable that the data switch 303 be configured in terms of hardware to communicate, in an initial state, data between the network interface 208 and the main arithmetic unit 201 even without an instruction from the sub arithmetic unit 301.

The first data interface 304 is an interface for the energy-saving controller 202 to communicate data to the main arithmetic unit 201. The first data interface 304 also has the function as a buffer in communicating data to the main arithmetic unit 201.

The second data interface 305 is an interface for the energy-saving controller 202 to communicate data to the network interface 208. Like the first data interface 304, the second data interface 305 also has the function as a buffer in communicating data to the network interface 208.

The serial controller 306 is an interface for the sub arithmetic unit 301 to communicate a setting signal for the network interface 208 between the main arithmetic unit 201 and the network interface 208. Specifically, for example, the serial controller 306 operates as an interface for communicating the sub arithmetic unit program to the main arithmetic unit 201 when the main arithmetic unit 201 writes the sub arithmetic unit program in the sub arithmetic unit RAM 302. In addition, for example, the serial controller 306 operates as an interface when the sub arithmetic unit 301 communicates a setting signal to the network interface 208 by using the SMI.

The general IO port 307 is an interface for the sub arithmetic unit 301 to communicate a setting signal to a device connected to the energy-saving controller 202. Specifically, for example, the general IO port 307 operates as an interface when the sub arithmetic unit 301 outputs a CKE_LOW signal to the transistor 207. The controller internal bus 308 interconnects the sub arithmetic unit 301, the data switch 303, the serial controller 306, the sub arithmetic unit RAM 302, and the general IO port 307.

The configuration of the information processing apparatus 101 illustrated in FIGS. 2 and 3 is only one example, and is not limited to this example.

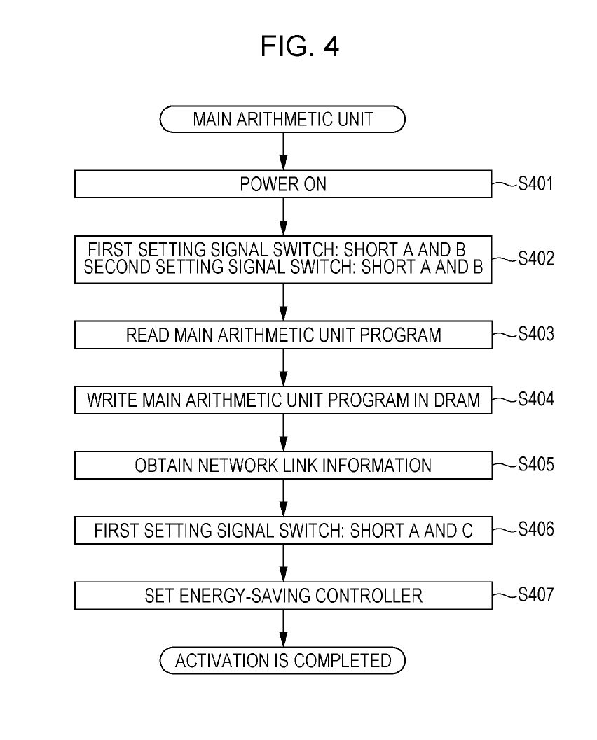

Next, the flow of each process performed by the information processing apparatus 101 will be described using FIGS. 4 to 6. First, FIG. 4 illustrates the flow of a process performed at activation of the main arithmetic unit 201 in the exemplary embodiment. Note that this flow is only exemplary, and the exemplary embodiment is not limited thereto.

First, for example, in response to application of power to the information processing apparatus 101, power is supplied to the main arithmetic unit 201, thereby activating the main arithmetic unit 201. Specifically, for example, the main arithmetic unit 201 is activated in response to turning on a power switch of the information processing apparatus 101 by the user (S401). At this point of time, power is also supplied to the sub arithmetic unit 301; in an initial state, however, the sub arithmetic unit 301 is in a reset state. An initial value is set for setting information used by the main arithmetic unit 201 for controlling the main arithmetic unit DRAM 204 (hereinafter, referred to as a DRAM setting signal).

Next, the first setting signal switch 205 and the second setting signal switch 206 switch their paths of a setting signal so as to communicate a setting signal between the network interface 208 and the main arithmetic unit 201. Specifically, for example, the first setting signal switch 205 and the second setting signal switch 206 are each configured to short the A terminal and the B terminal in an initial state. Alternatively, 5402 may be executed after S404, and the first setting signal switch 205 and the second setting signal switch 206 may be controlled by the main arithmetic unit 201. Specifically, the main arithmetic unit 201 may control the first setting signal switch 205 and the second setting signal switch 206 so as to communicate a setting signal between the main arithmetic unit 201 and the network interface 208. That is, the main arithmetic unit 201 may control the first setting signal switch 205 and the second setting signal switch 206 so as to short their A terminals and B terminals.

Next, the main arithmetic unit 201 reads the main arithmetic unit program from the ROM 203 (S403). The main arithmetic unit 201 writes the main arithmetic unit program, read in S403, in the main arithmetic unit DRAM 204 (S404).

Next, the main arithmetic unit 201 obtains network link information. Specifically, for example, the main arithmetic unit 201 obtains, from the network interface 208, network link information, such as a link speed or a clock frequency of the network interface 208, by using the SMI with the network interface 208 (S405).

Next, the main arithmetic unit 201 controls the first setting signal switch 205 so that a setting signal is communicated between the main arithmetic unit 201 and the sub arithmetic unit 301 (S406). That is, the main arithmetic unit 201 controls the first setting signal switch 205 so as to short the A terminal and the C terminal. The main arithmetic unit 201 sets the network link information in the energy-saving controller 202 (S407). Specifically, for example, the main arithmetic unit 201 sets the network link information, obtained in S405, in the first data interface 304 and the second data interface 305 via the serial controller 306.

As has been described above, the data switch 303 is configured to communicate, in an initial state, data between the network interface 208 and the main arithmetic unit 201. Therefore, upon completion of activation of the main arithmetic unit 201 in accordance with the above flow, the main arithmetic unit 201 communicates data to the network interface 208 until the main arithmetic unit 201 enters a power saving state. That is, even in a state where the sub arithmetic unit program has not been written in the sub arithmetic unit RAM 302, the main arithmetic unit 201 communicates data to the network interface 208, thereby shortening the activation time.

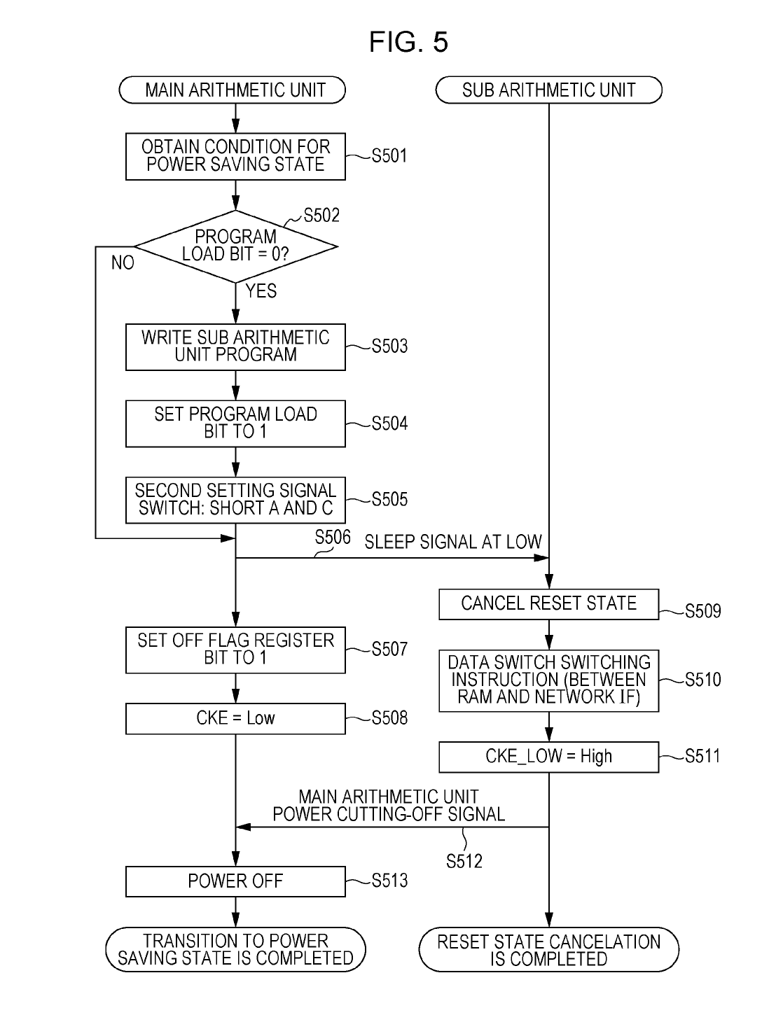

Next, FIG. 5 illustrates the flow of a process performed when the main arithmetic unit 201 enters a power saving state and the reset state of the sub arithmetic unit 301 is canceled in the exemplary embodiment. Note that it is assumed that the program load bit and the off flag register bit are both set to zero after power is applied to the information processing apparatus 101.

First, the main arithmetic unit 201 obtains a condition for entering a power saving state (S501). Specifically, for example, the main arithmetic unit 201 obtains a condition for entering a power saving state in the case where the user performs no operation on the information processing apparatus 101 for a preset period of time. Alternatively, for example, the main arithmetic unit 201 may obtain a condition for entering a power saving state in the case where the user explicitly gives an instruction to the information processing apparatus 101 to enter a power saving state.

Next, the process proceeds to S503 in the case where the program load bit is zero and to S506 in the case where the program load bit is one (S502). That is, the process proceeds to S503 in the case where the main arithmetic unit 201 has not read the main arithmetic unit program from the ROM 203 after activation of the main arithmetic unit 201, and the process proceeds to S506 in the case where the main arithmetic unit 201 has read the main arithmetic unit program from the ROM 203.

In the case where the program load bit is zero in S502, the main arithmetic unit 201 writes the sub arithmetic unit program in the sub arithmetic unit RAM 302 (S503). The main arithmetic unit 201 sets the program load bit to one (S504). Furthermore, the main arithmetic unit 201 controls the second setting signal switch 206 so that a setting signal is communicated between the sub arithmetic unit 301 and the network interface 208 (S505). That is, the main arithmetic unit 201 controls the second setting signal switch 206 so as to short the A terminal and the C terminal.

Next, in the case where the program load bit is one in S502, and after the main arithmetic unit 201 controls the second setting signal switch 206 in S505, the main arithmetic unit 201 transmits a sleep signal that is low to the sub arithmetic unit 301 (S506).

Next, the main arithmetic unit 201 sets the off flag register bit to one (S507). Here, since the off flag register bit is data that represents whether the state is immediately after application of power to the information processing apparatus 101 or the information processing apparatus 101 is restored from a power saving state, the off flag register bit is set to one after S507. Note that S507 may be performed at any time as long as it is after S501 and before S513. In order to validate the self-refresh function of the main arithmetic unit DRAM 204, the main arithmetic unit 201 outputs a CKE signal that is low (S508).

In contrast, the sub arithmetic unit 301, which has obtained the sleep signal which is low in S506, cancels the reset state of the sub arithmetic unit 301 (S509). The sub arithmetic unit 301, whose reset state has been canceled, controls the data switch 303 so that data is communicated between the sub arithmetic unit RAM 302 and the network interface 208 (S510). Furthermore, in order to validate the self-refresh function of the main arithmetic unit DRAM 204 even in the case where the power of the main arithmetic unit 201 is turned off, the sub arithmetic unit 301 outputs a CKE_LOW signal that is high (S511).

Next, the sub arithmetic unit 301 outputs a signal for cutting off the power to the main arithmetic unit 201 to a power supply circuit (S512). When the main arithmetic unit 201 obtains this signal, the power supplied to the main arithmetic unit 201 is cut off (S513).

As described above, cutting off the power supplied to the main arithmetic unit 201 and canceling the reset state of the sub arithmetic unit 301 allows an arithmetic unit that communicates a setting signal and data to the network interface 208 to be switched from the main arithmetic unit 201 to the sub arithmetic unit 301. Therefore, the power consumption of the information processing apparatus 101 is reduced, compared with a normal state. In the case where the network interface 208 obtains data from the network 102 in a power saving state, the sub arithmetic unit 301 temporally writes the data in the sub arithmetic unit RAM 302. Note that this flow is only exemplary, and the exemplary embodiment is not limited thereto.

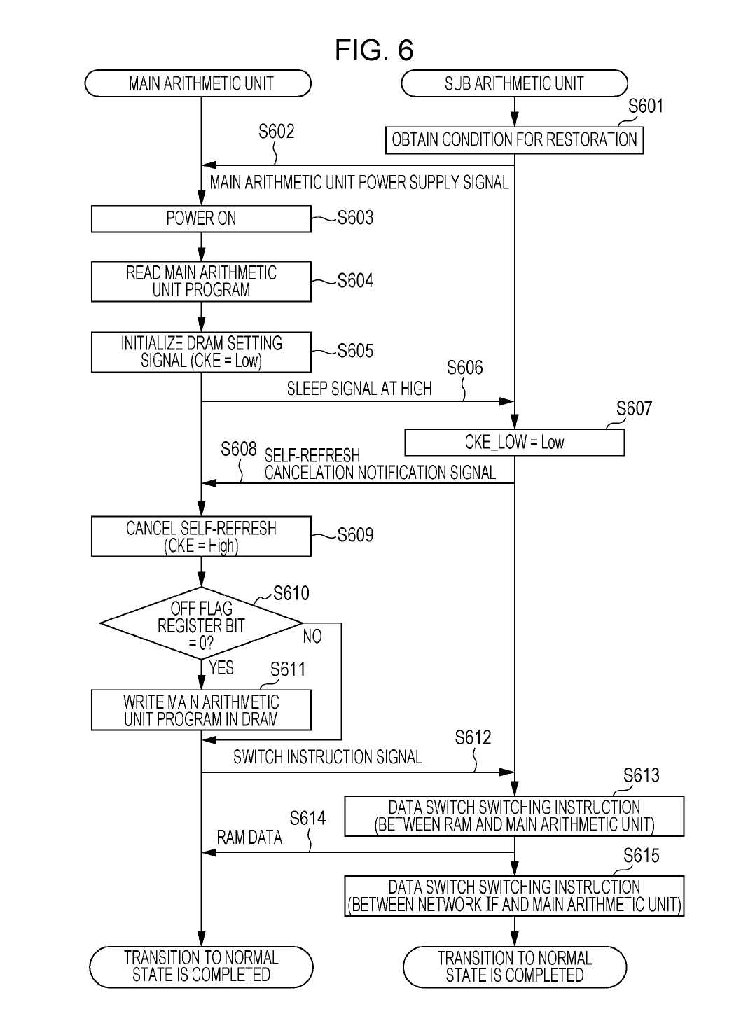

Next, FIG. 6 illustrates the flow of a process performed when the main arithmetic unit 201 is restored from a power saving state to a normal state and the sub arithmetic unit 301 enters a reset state in the exemplary embodiment.

First, the sub arithmetic unit 301 obtains a condition for entering a normal state (S601). Specifically, for example, the sub arithmetic unit 301 obtains a condition for returning to a normal state in the case where the user gives an instruction to the information processing apparatus 101 to cancel a power saving state. Alternatively, the sub arithmetic unit 301 obtains a condition for returning to a normal state in the case where the sub arithmetic unit 301 determines that data received from the network interface 208 is data that is addressed to the sub arithmetic unit 301 to be processed.

Next, in response to an instruction from the sub arithmetic unit 301 (S602), power is supplied to the main arithmetic unit 201 (S603). Next, the main arithmetic unit 201, to which power has been supplied, reads the main arithmetic unit program from the ROM 203 (S604). Furthermore, the main arithmetic unit 201 initializes setting signals of the main arithmetic unit DRAM 204 (S605). Here, the setting signals of the main arithmetic unit DRAM 204 include a CKE signal, and the main arithmetic unit 201 outputs the CKE signal which is low.

Next, the main arithmetic unit 201 outputs a sleep signal that is high to the sub arithmetic unit 301 (S606). Having obtained the signal, the sub arithmetic unit 301 outputs the CKE_LOW signal which is low to the transistor 207 (S607), thereby invalidating the self-refresh function of the main arithmetic unit DRAM 204, and outputs a signal notifying that the forced self-refresh mode of the main arithmetic unit DRAM 204 is canceled by the sub arithmetic unit 301 to the main arithmetic unit 201 (S608). In response to this, the main arithmetic unit 201 makes the CKE signal for the main arithmetic unit DRAM 204 high, and cancels the self-refresh mode of the main arithmetic unit DRAM 204.

Next, the process proceeds to S611 in the case where the off flag register bit is zero and to S612 in the case where the off flag register bit is one (S610). In the case where the off flag register bit is zero, the state is immediately after the application of power to the information processing apparatus 101; thus, the main arithmetic unit 201 writes the main arithmetic unit program in the main arithmetic unit DRAM 204 (S611). In the case where the off flag register bit is one, the information processing apparatus 101 is on the way to returning from a power saving state, and the main arithmetic unit program held by the self-refresh mode has already been written in the main arithmetic unit DRAM 204; thus, the main arithmetic unit 201 does not write the main arithmetic unit program in the main arithmetic unit DRAM 204.

Next, when the sub arithmetic unit 301 obtains a switch instruction signal from the main arithmetic unit 201 (S612), the sub arithmetic unit 301 controls the data switch 303 so that data is communicated between the sub arithmetic unit RAM 302 and the main arithmetic unit 201 (S613). The sub arithmetic unit 301 transmits data written in the sub arithmetic unit RAM 302 in a power saving state to the main arithmetic unit 201 (S614).

Next, the sub arithmetic unit 301 controls the data switch 303 so that data is communicated between the main arithmetic unit 201 and the network interface 208 (S615). In S614, the main arithmetic unit 201, which has obtained data from the sub arithmetic unit 301, writes the data in the main arithmetic unit DRAM 204 and then performs a process in accordance with the obtained data. Specifically, for example, if the main arithmetic unit 201 obtains print data, the main arithmetic unit 201 performs a print process after performing an image forming process.

As described above, when the main arithmetic unit 201 is restored from a power saving state to a normal state, while holding data obtained by the sub arithmetic unit 301 from the network interface 208 in a power saving state in the main arithmetic unit DRAM 204, the main arithmetic unit 201 communicates data to the network interface 208, like a state immediately after activation.

The present invention is not construed to be limited to the above-described exemplary embodiment, and various modifications may be made. For example, the configuration illustrated in the above-described exemplary embodiment may be substituted with substantially the same configuration, the configuration that has the same effects, or the configuration achieving the same object. Specifically, for example, the configuration of the information processing apparatus 101 or the flow of each process performed by the information processing apparatus 101 is only exemplary and is not limited thereto.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a network interface;
a main arithmetic unit that is activated in response to power being supplied thereto, and that performs arithmetic operation on the basis of a preset first program;
a sub arithmetic unit that performs arithmetic operation on the basis of a second program written by the main arithmetic unit; and
a data switch that switches, under control of the sub arithmetic unit, a path of data communicated between the network interface and the main arithmetic unit or the sub arithmetic unit,
wherein the data switch is configured to communicate, in an initial state, the data between the network interface and the main arithmetic unit.

2. The information processing apparatus according to claim 1, further comprising a setting signal switch that switches, under control of the main arithmetic unit, a path of a setting signal for the network interface, the setting signal being communicated between the network interface and the main arithmetic unit or the sub arithmetic unit.

3. The information processing apparatus according to claim 1, further comprising:
a main arithmetic unit memory in which the first program is written; and
a determination unit that determines whether the first program has already been written in the main arithmetic unit memory,
wherein, in transition of the main arithmetic unit to a power saving state, in a case where the determination unit determines that the first program has not been written, the main arithmetic unit writes the first program.

4. The information processing apparatus according to claim 2, further comprising:
a main arithmetic unit memory in which the first program is written; and
a determination unit that determines whether the first program has already been written in the main arithmetic unit memory,
wherein, in transition of the main arithmetic unit to a power saving state, in a case where the determination unit determines that the first program has not been written, the main arithmetic unit writes the first program.

5. The information processing apparatus according to claim 1, wherein the setting signal switch is set to communicate the setting signal between the network interface and the main arithmetic unit after application of the power.

6. The information processing apparatus according to claim 2, wherein the setting signal switch is set to communicate the setting signal between the network interface and the main arithmetic unit after application of the power.

7. The information processing apparatus according to claim 3, wherein the setting signal switch is set to communicate the setting signal between the network interface and the main arithmetic unit after application of the power.

8. The information processing apparatus according to claim 4, wherein the setting signal switch is set to communicate the setting signal between the network interface and the main arithmetic unit after application of the power.

9. The information processing apparatus according to claim 1, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

10. The information processing apparatus according to claim 2, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

11. The information processing apparatus according to claim 3, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

12. The information processing apparatus according to claim 4, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

13. The information processing apparatus according to claim 5, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

14. The information processing apparatus according to claim 6, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

15. The information processing apparatus according to claim 7, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

16. The information processing apparatus according to claim 8, wherein, in transition of the main arithmetic unit to the power saving state, the setting signal switch is set to communicate the setting signal between the main arithmetic unit and the sub arithmetic unit, and is set to communicate the setting signal between the network interface and the sub arithmetic unit.

17. An image processing method for causing a computer to function as:
a network interface;
a main arithmetic unit that is activated in response to power being applied thereto, and that performs arithmetic operation on the basis of a preset first program;
a sub arithmetic unit that performs arithmetic operation on the basis of a second program written by the main arithmetic unit; and
a data switch that switches, under control of the sub arithmetic unit, a path of data communicated between the network interface and the main arithmetic unit or the sub arithmetic unit,
wherein the data switch is configured to communicate, in an initial state, the data between the network interface and the main arithmetic unit.

18. A non-transitory computer readable medium storing a program causing a computer to function as:
a network interface;
a main arithmetic unit that is activated in response to power being applied thereto, and that performs arithmetic operation on the basis of a preset first program;
a sub arithmetic unit that performs arithmetic operation on the basis of a second program written by the main arithmetic unit; and
a data switch that switches, under control of the sub arithmetic unit, a path of data communicated between the network interface and the main arithmetic unit or the sub arithmetic unit,
wherein the data switch is configured to communicate, in an initial state, the data between the network interface and the main arithmetic unit.
